(19) United States
(12) Patent Application Publication
(10) Pub. No.: US 2013/0197934 A1
(43) Pub. Date: Aug. 1, 2013

(54) SYSTEM AND METHOD FOR INTEGRATING BIOMARKER TEST RESULTS INTO POINT OF DISPENSATION DECISION MAKING

(71) Applicant: Patricia Trifunov, Wynnewood, PA (US)

(72) Inventor: Patricia Trifunov, Wynnewood, PA (US)

(73) Assignee: VELOCITY BIOGROUP CORPORATION, Wynnewood, PA (US)

(21) Appl. No.: 13/359,439

(22) Filed: Jan. 26, 2012

(51) Int. Cl. G06Q 50/24

(52) U.S. Cl. 705/3

(57) ABSTRACT

An IC card used for linking components of a health care transaction to results from a biomarker measurement, test or procedure, including an algorithmic-real time calculation of optimized therapy choice(s) is provided. The on-card, dynamic processing capabilities of the card can facilitate payment, selection and/or reimbursement authorization of drug, biologic or medical devices as a result of biomarker findings in order to optimize benefits and/or mitigate the risks of therapy. The card may be employed for risk mitigation strategies by coding for safety biomarker results that trigger immediate point-of-dispensation re-evaluation or discontinuation of product.

### FIELD OF THE INVENTION

The present invention relates to the field of health care management, and, more particularly, to a computer implemented system and method for integrating biomarker test results into point of dispensation decision making for patient safety and improved therapeutic benefit.

### BACKGROUND

The pharmaceutical, biologic and medical device industries are hampered by their inability to justify the cost of new innovations. The value proposition of these innovations must be made to a multi-stakeholder community including patients, health care service providers, payers, etc. Personalized medicine demands that new products show their capability to present an overall safe and effective value proposition for population health, while specifically serving the individual patient.

Furthermore, the value proposition must ensure the benefits of innovation while mitigating as many risks as practically possible, based on the unique profile of the individual. Therefore, new technologies are required to facilitate this individualized approach to medicine to solve the critical challenges in medicine, as it is practiced today. In addition, technology advances at a pace that makes it very difficult for health care prescribers to fully understand what is fully available to them, including the inherent benefits and risks of relevant therapies. New technologies to augment and leverage safe and informed health care prescriber decision-making can improve health care system quality, lower safety risks and raise therapeutic benefit outcomes for each patient within that system.

Some of the key challenges that new technologies must address include: 1) facilitating the use of biomarkers, 2) using biomarker test results in decision making prior to product dispensation, 3) encouraging patient adherence, and 4) addressing the cost and time burdens of prior authorization for biomarker validation.

A biomarker is defined as a characteristic that is objectively measured and evaluated as an indicator of normal biological process, pathogenic processes, or biological responses to a therapeutic intervention. See, Biomarkers Definition Working Group (2001), Clinical Pharmacology and Therapeutics, 69, pp. 89-95. It is now understood that biomarkers will play a significant role in value proposition development, personalized medicine, as well as safe, cost-effective innovation delivery. One of the many challenges in medical decision-making surrounds how to access biomarker data prior to the time that prescriptions or devices are prescribed or dispensed. Similarly, pharmacy benefit managers (PBM's) or medical equipment (device) suppliers are stymied by the same inability to easily access that same information for consideration in their product delivery role.

Biomarkers can reduce uncertainty in drug, biologic or device use by providing quantitative predictions about their performance. These biomarkers can play a valuable role in ensuring the earliest detection of unsafe medications. In the intended use of the new FDA Sentinel Initiative, by 2012 the FDA will be able to proactively examine the health records of 100 million US patients in a wide array of collaborating institutions for evidence of safety events or signals of adverse reactions from drug use. This post-market safety monitoring will provide innovators with immediate feedback on issues of FDA concern through active surveillance rather than passive surveillance, as was previously conducted. As a result the demands on the biopharmaceutical and medical device industry to respond proactively to the new system will require an automated system like the IC Card in order to activate an immediate response. For example, if any newly approved, or “Phase 4 under-surveillance” products prove harmful to a limited number of individuals in larger population use, the IC card can respond to any activated biomarker signal, such as an elevated liver enzyme, specific to an individual patient and deactivate continued prescription authorizations. Such capabilities will enable innovators to maintain market access, enhance patient safety, while ensuring the continued delivery of valuable medications to the right patient populations.

However, given the complexity of medical knowledge, we now understand that usually no one factor is a certain predictor of capability of a drug, biologic or device to safely effect a medical outcome in all individuals all the time. Some treatments demand a weighted and prioritized analysis of multiple factors for optimized product selection. For instance, today in stroke prevention for the use of oral anticoagulants, the CHADS₂ scoring system is used. This system takes several risk factors for biomarkers plus age, history and co-occurring disease states to determine whether the score justifies the patient use of the drug. The scoring requires moving beyond biomarkers to both phenotypic and familial contributors. Those at the phenotypic level (observed—such as gender, weight, age or race), and familial (recorded—through patient histories) must be assembled together with biomarkers into a computational matrix for selecting the best treatment choice. This increases the challenge for effective prescribing, especially since many health care prescribers initiate treatment at the time of the office visit and/or cannot link ordered biomarker tests into their phenotypic or history information. Currently, the link up of the tests and analysis described above at the time of product dispensation does not exist.

Prior authorization is the mechanism by which health care payers or service providers will not allow for the reimbursement of drugs, biologics or medical devices until certain “use criteria” are met. These frequently involve validation of new product use through test results from biomarkers, or through failure on other products. “Fail first” policies are particularly concerning to many health care prescribers and patients who believe that quality care should not be based on such a system. The initial products may be lower priced or may have a proven track record of use, but this does not make them the best choice for patient care. Physicians, pharmacists, pharmacy benefit managers and medical suppliers do not have the time in today's capitated, cost-contained environment for the paper work and phone time demands of prior authorization. Dealing with multiple health plans on claims, prior authorizations, and pharmaceutical formularies is estimated to cost at least $83,975 per physician annually in the United States, according to a study published for Health Affairs, August, 2011.

### SUMMARY

The present invention utilizes a portable computing device, such as an IC card, to integrate biomarker test results into the point of dispensation decision-making process for drug, biologic, and medical device treatments. Additionally, the portable computing device can assist the health care service provider, prescriber, payer, or dispenser of the drug, biologic, or medical device in ensuring adherence to guidelines promulgated by the health care service provider, prescriber, payer, or dispenser, or regulator(s) in making the most appropriate health care decisions. This is particularly valuable when complex, multi-factorial biomarkers along with phenotypic and patient history inputs are used in determining an appropriate treatment. In essence, this becomes an informing-controlling feedback function to support voluntary or involuntary regulator-imposed risk mitigation strategies.

In the simplest case, many drugs have a single biomarker known or available to predict the ability of that drug to effect a response in the patient. For example, a simple blood test can measure the impact of HMG-CoA Reductase Inhibitors (commonly called “Statins”) on reducing “bad” cholesterol known as low-density lipoprotein (LDL). Statins come in many strengths and doses, and the new more potent formulations are often ordered behind cheaper, less potent generic drugs before the others can be used to the compromise of patient health outcomes. According to the methods and systems of the present invention, the portable computing device can be presented by the patient at the pharmacy, and if warranted based on uploaded LDL results, the portable computing device can indicate suitability for prescribing a statin therapy—thus averting prior authorization. Likewise, as the therapy progresses, the need for a change in therapy may be called for if the first medication is not effective. This could involve dosing increases, or it could involve a switch to an entirely new medication.

The drug, biologic, or medical device prescriber can order the lab test and prearrange for the appropriate product choice simultaneously, based on the varying lab test scenarios set forth in a “provisional prescription”. For example, the provisional prescription may set forth a set of drugs according to a specified order of preference. In the example with regard to statins, the provisional prescription might allow for a new and expensive statin “A” as the first choice and a generic statin “B” as the second choice. At the pharmacy, the patient presents the portable computing device which is then connected to a pharmacy computer system which is configured to download the lab test results directly to the portable computing device. A computer program encapsulating expert knowledge relating to selection of cholesterol-reducing drugs can be executed on the portable computing device to arrive at a decision as to which drug to be dispensed, without prior authorization. In certain cases, the portable computing device can even make recommendations as to other treatments. Notably, the integration of lab, health care prescriber choice and pharmacy on the portable computing device eliminates the processing time between these electronically disconnected services.

Perhaps even more significantly, the critical and emerging role of payers and/or health care service providers contributes to optimized medical decisions using the portable computing device. Referring again to the above example, for many of these stakeholders, appropriate statin selections and dosing have been devised through a team of medical experts who have determined the ideal selection of product choices based on extensive reviews of clinical trial results and retrospective data analyses of product use within their care systems post-FDA approval. The collective decision making of experts in care can sometimes trump that of the individual physician practicing from limited knowledge and experience.

These practice standards or guidelines for care are intended to support the highest quality and most cost-effective choices for the individual patient, based on his or her unique biomarker profile. This is the essence of personalized medicine. The care guidelines of a payer, health care delivery system or an accrediting body such as the American College of Cardiology, or the Pharmacy and Therapeutics Committee of a health plan in the example with statins can be programmed into the portable computing device to ensure that high quality care is delivered, value to the payer is optimized, and that the patient's satisfaction and out-of-pocket expenditures are appropriate. Ultimately, the portable computing device and its delivery system will rapidly identify non-responders to the current standards of care and successfully guide them through the reimbursement system without the need for expensive or time-consuming prior authorization or fail-first processes.

Other aspects and embodiments of the invention are also contemplated. The foregoing summary and the following detailed description are not meant to restrict the invention to any particular embodiment but are merely meant to describe some embodiments of the invention.

### BRIEF DESCRIPTION OF THE DRAWINGS

FIG. 1 is a diagram of an exemplary system for integrating biomarker test results into point of dispensation decision making, according to an embodiment of the present invention;

FIG. 2 is a diagram of an exemplary process flow of a method for integrating biomarker test results into point of dispensation decision making, according to an embodiment of the present invention;

FIG. 3 is a block diagram of an exemplary architecture for an integrated circuit (IC) card useable in conjunction with the present invention, according to an embodiment of the present invention;

FIG. 4(a) illustrates the IC card being connected to an IC card reader/writer, according to an embodiment of the present invention;

FIG. 4(b) illustrates the IC card reader/writer connected to a personal computer, according to an embodiment of the present invention;

FIG. 5 is a block diagram of an exemplary memory of the IC card showing several files used to store patient health care information and an executable program, according to an embodiment of the present invention;

FIG. 6 is a block diagram of an exemplary architecture for a smart phone useable in conjunction with the present invention, according to an another embodiment of the present invention; and

FIGS. 7(a) to 7(c) illustrates various exemplary graphical charts showing patient treatment adherence, according to an embodiment of the present invention.

### DETAILED DESCRIPTION

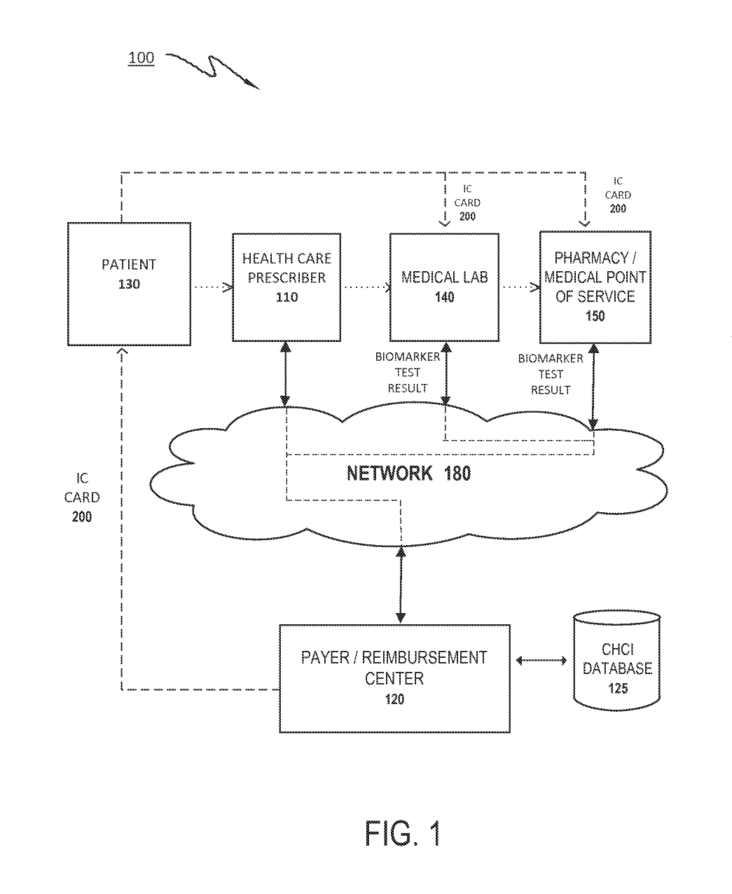

FIG. 1 illustrates an exemplary system 100 for integrating biomarker test results into point of dispensation decision making, according to an embodiment of the present invention. As depicted, the system 100 includes a patient 130, a health care prescriber 110, a medical lab 140, a pharmacy/medical point of service 150, and a payer/reimbursement center 120. The health care prescriber 110, the medical lab 140, the pharmacy/medical point of service 150, and the payer/reimbursement center 120 can be connected via a network 180. The payer/reimbursement center 120 includes a Central Health Care Information (CHCI) database 125. Although FIG. 1 shows only one of each entity, it is to be understood that the system 100 would in practical operation be able to accommodate a large number of patients, health care prescribers, pharmacies and other medical points of service under numerous different insurance plans and coverage options.

As will be described in greater detail, in operation, the patient 130 visits the health care prescriber 110 who then writes a provisional prescription listing one or more possible treatment option, and orders a biomarker test. The payer/reimbursement center 120 receives the provisional prescription and medical record information for the patient 130 from the health care prescriber 110, and thereupon issues a portable computing device, such as an IC card 200, to the patient 130. After the patient 130 has the biomarker test performed at the medical lab 140, the patient 130 is notified that he or she should bring the portable computing device to the pharmacy/medical point of service 150. At the pharmacy/medical point of service 150, the portable computing device is connected to a pharmacy computer system which uploads the biomarker test results to the portable computing device. Using logic pre-loaded on the portable computing device, the portable computing device then determines which (if any) of the listed treatments are to be authorized. The portable computing device can have stored therein patient and insurance plan identifiers, unique payer identifiers to connect the pharmacy computer system via the portable computing device to the biomarker results, payer codes to authorize the type and frequency of allowable biomarker tests, and key phenotypic traits contributing to payer-specific algorithms or best practice standards of care. In some cases, familial contributors and other relevant factors will be also included. Accordingly, the drug, biologic, or medical device selection can be made at the point of dispensation without prior authorization.

As used herein, the health care prescriber 110 can include any person authorized to prescribe a treatment, such as a drug, biologic, or medical device. Examples of such a health care prescriber 110 include, but are not limited to, a medical doctor, a psychiatrist, an osteopathic physician, a dentist, and a physician's assistant or a nurse who by law is authorized to write prescriptions. In certain instances, the health care prescriber 110 will be an entity such as a hospital employing or contracting with the person authorized to prescribe the treatment.

The medical lab 140 can include any place where tests are done on clinical specimens to obtain biomarker information for the patient 130 pertaining to the diagnosis, treatment, and prevention of disease. In some instances, the actual tests will be done at a location different from the medical lab 140. In some instances, the specimen collection will take place at the office of the health care prescriber 110 or the home of the patient rather than in the lab. In other instances, the specimen collection and the test may be done at the health care prescriber 110 or at a lab operated by the health care prescriber 110. For the purposes of the present disclosure, the location(s) where the specimen(s) are collected and the test is done are not relevant.

The pharmacy/medical point of service 150 can include any location where a drug, biologic, or medical device is dispensed. This can include a community pharmacy, a hospital pharmacy, or a medical supply outlet. In certain instances, contact between the patient 130 and the pharmacy/medical point of service 150 will take place solely over the Internet, with the drug, biologic, or medical device shipped to the patient 130 via mail. In such a case, the patient may be able to connect the portable computing device to the computer system of the pharmacy/medical point of service 150 remotely using an appropriate IC card reader/writer connected to the patient's personal computer, for example.

The payer/reimbursement center 120 is an organization which is used by a variety of different health care payers to adjudicate drug, biologic, and medical device authorizations. The payer/reimbursement center 120 is able to electronically communicate with the health care prescriber 110, the medical lab 140, and the pharmacy/medical point of service 150. The payer reimbursement center 120 functions include: (1) maintaining a reimbursement center database (the CHCI database 125) useful for approval for all drug, biologic and device requests, (2) providing payer-sanctioned protocols and guidelines for appropriate use of biomarker tests, and (3) providing a list of payer-approved vendors for biomarker services.

The payer/reimbursement center 120 includes a computer system, software, and the CHCI database 125. The computer system includes a central processor, memory (RAM, ROM, etc.), fixed and removable code storage devices (hard drive, floppy drive, CD, DVD, memory stick, etc.), input/output devices (keyboards, display monitors, pointing devices, printers, etc.), and communication devices (Ethernet cards, WiFi cards, modems, etc.). The software to accomplish the methods described below may be stored on a computer-readable medium and may also be transmitted as an information signal, such as for download. The CHCI database 125 can include any computer data storage system, but, preferably, is a relational database organized into logically-related records. Preferably, the CHCI database 125 includes a Database Management System (DBMS) useful for management of the data stored within the CHCI database 125. Representative DBMS that may be used by the present invention include Oracle Database by Oracle Corp., DB2 by IBM, and the SQL Server by Microsoft. The database CHCI database 125 can either be a centralized or a distributed database.

Although not illustrated, the health care prescriber 110, the medical lab 140, and the pharmacy/medical point of service 150 have computers with central processors, memory (RAM, ROM, etc.), fixed and removable code storage devices (hard drive, floppy drive, CD, DVD, memory stick, etc.), input/output devices (keyboards, display monitors, pointing devices, printers, etc.), and communication devices (Ethernet cards, WiFi cards, modems, etc.).

Although the Internet is the preferred choice for the network 180 for communication among the illustrated entities, it is to be understood that other network elements could, alternatively, or in addition, be used. These include any combination of wide area networks, local area networks, public switched telephone networks, wireless or wired networks, intranets, the Internet or any other distributed processing network or system.

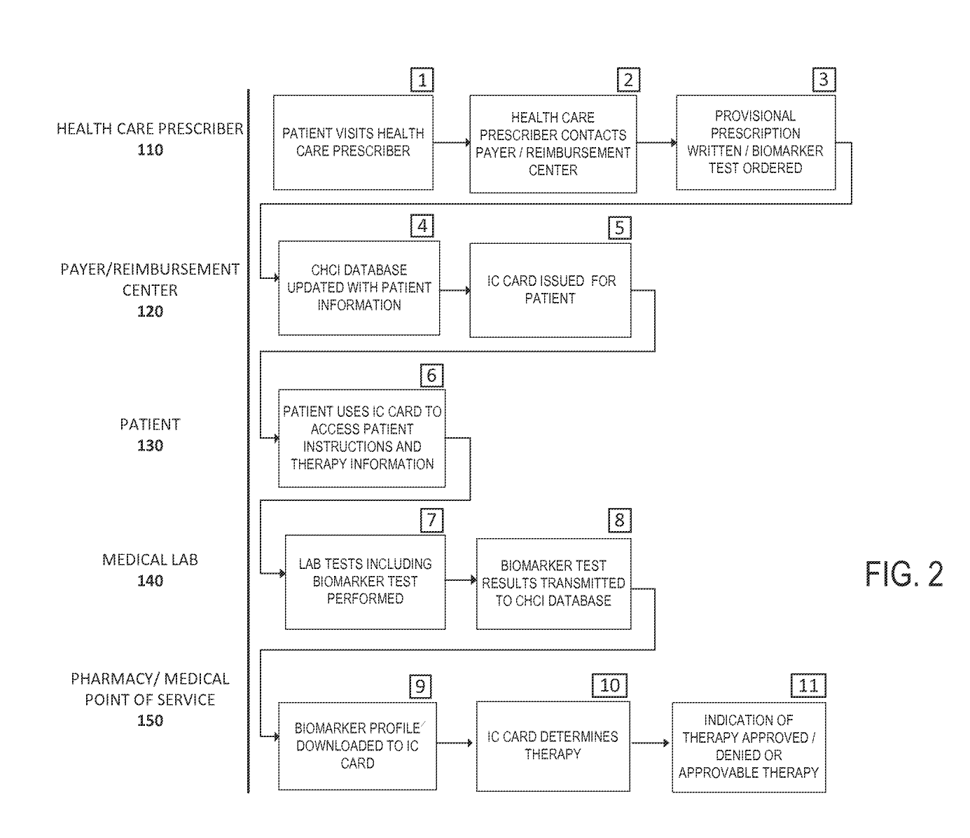

FIG. 2 is a diagram of an exemplary process flow of a method for integrating biomarker test results into point of dispensation decision making, according to an embodiment of the present invention. Initially, in step 1, the patient 130 visits the health care prescriber 110. Next, in step 2, after an assessment by the health care prescriber 110, the payer/reimbursement center 120 may be contacted for guidance on recommended treatments and payment polices for treatments. In step 3, a provisional prescription may be written and a biomarker test ordered. As an example, consider the patient 130 who presents with symptoms associated with diabetes. The biomarker test ordered might include a test to measure blood glucose as well a C-peptide test to determine whether the patient 130 is producing an adequate amount of (or any) insulin. The provisional prescription would list one or more oral drug or insulin, the choice dependent on the results of the biomarkers. The prescription would only be filled if the blood glucose test indicated the patient is diabetic. The choice of treatment would depend on the C-Peptide test. In the case where the C-Peptide test indicated that the patient was producing an inadequate amount of (or no) insulin, an insulin injectable would be prescribed rather than the oral medication. In step 5, the payer/reimbursement center 120 issues an integrated circuit (IC) card for the patient 130.

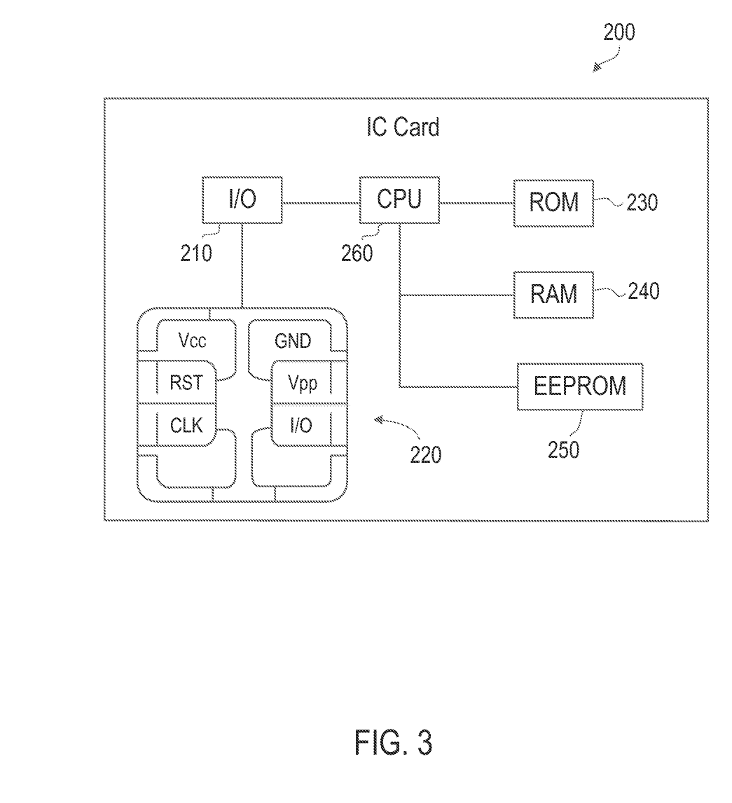

As is known in the art, an IC card is a pocket-sized card with embedded integrated circuits. An IC card (also known as a “smart card”) contains volatile memory and microprocessor components. Referring to FIG. 3, a block diagram of an exemplary architecture for an integrated circuit (IC) card 200 useable in conjunction with the present invention is illustrated. As illustrated, the IC card 200 includes an input/output module 210, a central processing unit (CPU) 260, read-only memory (ROM) 230, random access memory (RAM) 240, and an electrically erasable programmable read-only memory (EEPROM) 250. The IC card includes a contact pad 220 for reading/writing to/from the IC card 200. Preferably, the IC card used will conform to ISO 7816-1, -2, and -3 standards for physical and electrical characteristics. A representative IC card that may be used for the IC card 200 of the present invention is IC card part number CLXSU512KJ4/T=OED, having 64 k of EEPROM, manufactured by CardLogix Corporation, Irvine, Calif. While the IC card 200 illustrated herein includes a contact pad 200 which must be physically contacted with the reading mechanism of a card reader (e.g., swiped), it is to be understood that the IC card used herein could, alternatively, use a contactless mechanism to communicate with a terminal (e.g., communicate with the terminal using radio waves).

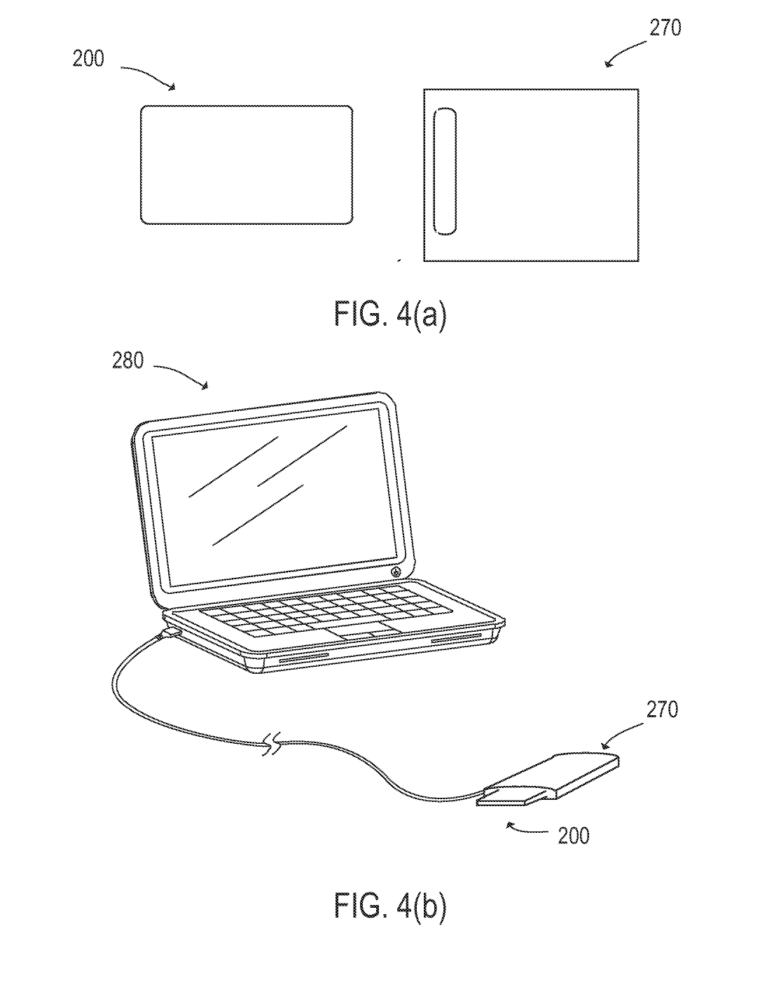

As shown in FIG. 4(a), the IC card 200 requires connection of the contact pad 220 with an appropriate IC card reader 270 to access information from the IC card 200. FIG. 4(b) shows the IC card reader 270 connected to a personal computer 280 via a USB port. When the IC card 200 is inserted into the IC card reader 270 which is connected to the personal computer 280, an application program in the personal computer 280 can access the information in the IC card 200, and write to the RAM 240. It is to be understood that the personal computer 280 would also need to have loaded into memory the appropriate device driver to access the IC card reader 270.

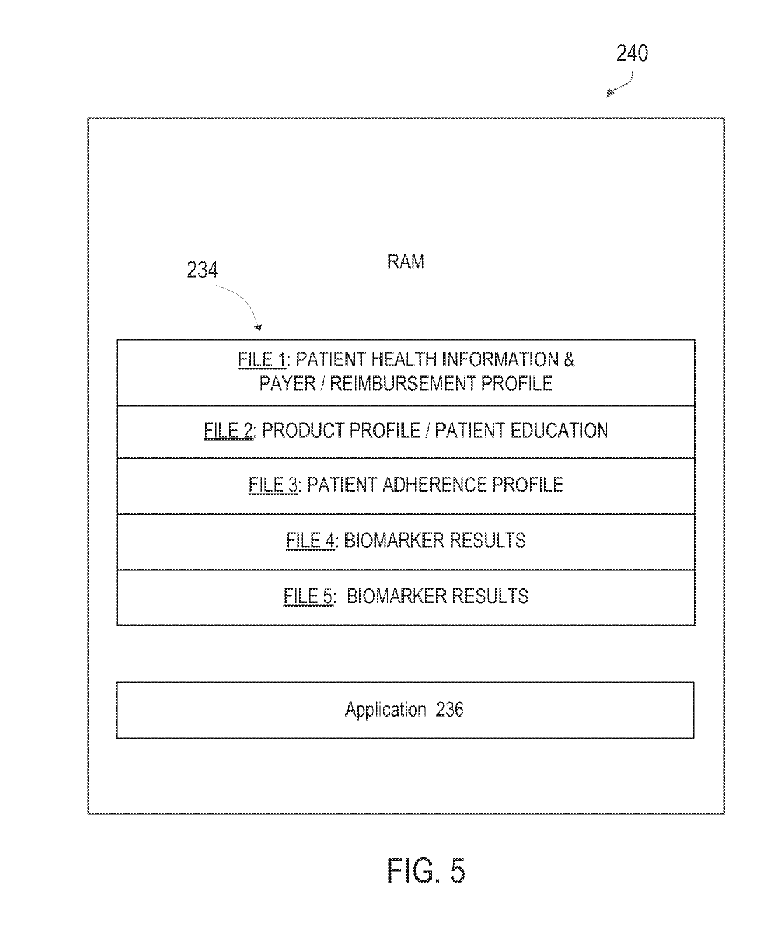

Referring to FIG. 5, a block diagram of an exemplary memory of the IC card 200 showing several files 234 used to store patient health care information and an application 236 used to store an executable program, according to an embodiment of the present invention, is illustrated.

“File 1” includes patient health information and the payer/reimbursement profile. Included within this file can be unique payer identifiers (health insurer, health care service providers) to connect the pharmacy computer system via the IC card 200 to biomarker results that can be accessed on-line at the pharmacy point-of-sale; payer codes to authorize the type and frequency of allowable biomarker tests; and key phenotypic traits contributing to payer-specific algorithms or best practice standards of care.

“File 2” includes product profiles/patient education information. Included in this file can be drug, biologic or medical device patient use instructions, dosing and administration or use guidelines, and an explanation of the critical role of biomarkers in care and the importance of adherence in meeting therapy goals. The file may also include various safety warnings and contraindications.

“File 3” includes the adherence profile. Included in this file can be information self-reported by the patient 130 as to actual frequency of usage of the prescribed treatment. This can be used to show the relationship between adherence and therapy results.

“File 4” and “File 5” include the biomarker test results. The biomarker test results requiring the highest degree of confidentiality (e.g., genetic biomarkers) will be stored in “File 5” whereas the less sensitive biomarker test results will be stored in “File 4”.

The privacy rules set forth in the Health Insurance Portability and Accountability Act (HIPAA) mandate that any individually identifiable health information must be maintained in strict confidence. As such, any information stored in the files 234 could be stored in encrypted format. Based on the nature of the information stored in the IC card, the payer or health care service provider may also choose one of more levels of security for access to the data stored in the files 234.
1) Identity protection—use of the IC card 200 for services requires validation through presentation of appropriate personal identification (such as a driver's license, a passport, a social security number, or employer-specific identification).
2) PIN and/or password protection—as above, but the user must also enter a specific alpha, symbol or numerical (or combined) code.
3) Biometric protection—use of beneficiary-specific data that cannot be compromised by identity theft. This is often referred to as military-grade security that represents a high level of confidentiality for the most sensitive disease categories such as HIV/AIDS and cancer. This level of security can also hold results from genetic level tests that may irrevocably mark the patient with certain predictive results for particular health outcomes.

The IC card 200 is able to file information based on the sensitivity of the data contained therein. The metaphor is that some files in a cabinet drawer may be locked and some may be easily accessed. Individual files allow accessibility based on these confidentiality constraints.

One example where information would have to be stored in a highly secure manner would be where the biomarker test result demonstrates an abnormal Huntingtin gene. The gene normally provides the genetic information for a protein that is also called “Huntingtin”. The mutation of the Huntingtin gene codes for a different form of the protein, whose presence results in gradual damage to specific areas of the brain. Life expectancy in Huntingtin's Disease is generally around 20 years following the onset of visible symptoms. The presence of the genetic mutation is known to validate a highly resource-intensive disease. This should remain confidential to the patient 130 and the health care prescriber health care prescriber 110, as opposed to outside payers or future insurers.

The health care prescriber 110 and the individual patient 130 may have access to genetic information; however, what is translated at the point of product dispensation will be simply be “yes” or “no” information about product reimbursement without the need for prior authorization.

Referring again to FIG. 2, in step 6, upon receipt of the programmed IC card 200, the patient 130 now has instructions on next steps for progressing his or her care. Accompanying the IC card 200 can be a card reader that allows the patient 130 to directly visualize where to visit for biomarker services as well as view other care instructions and educational material. The card reader may be a standalone device having a small display and/or be connectable to a personal computer (such as shown in FIG. 4(b)). The connection would be via hard wire (as shown) or wireless technology to allow for data transfer to provide a maximized viewing opportunity of the information contained in the IC card or a transmission of the information to other parties, if the patient so chooses.

Next, in step 7, at the medical lab 140, the IC card 200 is scanned. This elicits patient and payer identifiers authorizing use of the service, protocols for frequency of service and health care prescriber use and provision of information on out-of-pocket costs for the patient 130. In step 8, once the biomarker test results are determined, the medical lab 140 will electronically transmit an update to the CHCI Database 125, and send the customary notification to the health care prescriber 110 (usually in paper format). The patient 130 will be informed at the time of service provision how long to expect before results from the biomarker tests can be processed. Subsequently, the payer/reimbursement center 120 notifies the patient 130 via email and/or telephone that the biomarker test results are available.

Next, in step 9, at the pharmacy/medical point of service 150, the IC card 200 will automatically update from the payer/reimbursement center 120 when swiped. In step 10, the IC card 200 will execute a program to approve or disapprove a product provision or its refill, based at least in part on the biomarker(s) results. In the case of complex algorithmic pathways requiring real time computation of biomarker and potentially combined phenotypic or patient history data, the IC card 200 will calculate the approvable therapy based on programmed logic incorporating payer, health plan and/or accrediting body recommendations.

For example, in the case of using pharmaceuticals for Acute Coronary Syndrome following coronary angioplasty (heart artery “rotor rootering”) there exists a possibility that clots can break off from the walls of the arteries following he procedures, thus causing secondary heart attacks and strokes. These dangers can be offset with anti-platelet drugs that work as blood thinners—aspirin being one of the first that was discovered. The new generation of blood thinner, though superior, is known to work very dissimilarly in different people. In addition to thinning blood to avoid clotting, the medical community must also work to avoid excessive action of these agents that can result in both minor and serious bleeding up to, and including, death. Weight, age, race, gender, platelet reactivity, in addition to family and personal history, to name a few factors, can all impact the complex balance between factors that will determine the right mix of clot and bleeding prevention. Some of these factors can be measured with genetic tests, some with blood tests, and some through the health care prescriber's interactions with their patients to understand the patient's unique personal and family history.

In step 11, an indication as to the approved/denied therapy is outputted. In some cases, an indication as to an approvable and/or recommended therapy may also be outputted.

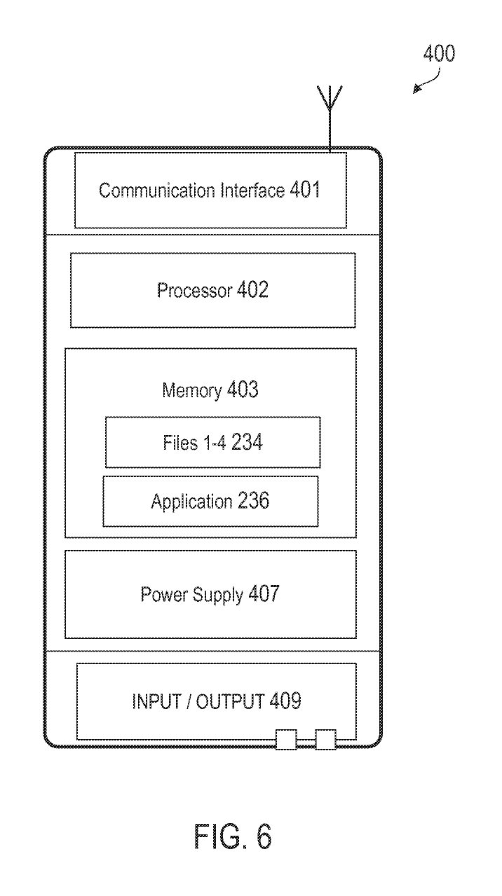

Referring to FIG. 6, a block diagram of an exemplary architecture for a mobile device 400 useable in place of the IC card 200, according to an alternate embodiment of the present invention, is illustrated. The mobile device 400 includes a communication interface 401, a processor 402, a memory 403 (including the Files 1-4 234 and the application 236 stored therein), a power supply 407 (e.g., a lithium-ion battery), and an input/output 409 (e.g., one or more USB ports, a QWERTY keyboard/touch screen equivalent). Representative mobile devices 400 useable in conjunction with the present invention include various smart phones, tablet computers, and notebook computers.

In this alternate embodiment, instead of providing the patient 130 with the IC card 200, the patient would use his or her own smart phone or tablet computer, for example, in place of the IC card 200. The mobile device 400 would be initially provisioned by the payer/reimbursement center 120 by download to the mobile device 400 via a secure Internet connection, for example. Instead of “swiping” the IC card 200, the data transfers could be done via a wired connection or a wireless connection. In certain embodiments, some patients 130 would use the IC card 200 provided by the payer/reimbursement center 120 while others would use their own mobile device 400. However, because present commercially available mobile devices lack security features required for HIPPA compliance and are relatively easy to “hack”, supplementary software or hardware would have to be employed to ensure proper security (e.g., encryption of stored data and wireless data packets). Still higher levels of security would be warranted when the mobile device 400 stores highly sensitive genetic biomarker information (e.g., where the biomarker reveals a genetic predisposition to a debilitating disease).

The refill process of drugs, biologics and medical devices can be programmed into the IC card 200 with ongoing approvals of therapy based on alternate scenarios: (1) Continuous biomarker monitoring without further health care prescriber interventions. In the statin illustration above, the IC card 200 can track reductions in low density lipoprotein (LDL) by instructing the patient on continuing biomarker test requirements. Use of test results can authorize continuing automatic approval of the pharmaceutical; however, a response to inadequate reductions in LDL can also be programmed into the card to automatically trigger the payer, plan, and/or health care prescriber to authorize a switch to a more potent medication. (2) Programmed interventions with health care prescriber feedback of progress made on biomarker results. The IC card 200 can not only prompt visits to the test center for biomarker services, it can also be used to prompt returns to the health care prescriber for follow-on check-ups regarding health status related to the use of the drug, biologic, or medical device in question. As before, the need to follow through health care prescriber intervention can come via email, wireless or telephone notification.

The relationship between biomarker test results, algorithm directives and patient adherence should all come together in optimizing medical benefit with the IC card 200. As noted, the IC card 200 contains a file (File 3) for patients willing to record their daily use of medications. The file can also simply store the pharmacy or medical supply refill rates for the patient to review. In a number of cases therapy results can be measured by biomarker changes. This record can help the patient or caregiver bring accountability to self-care and future therapeutic choices, particularly as therapies become increasingly expensive.

For example, if LDL reduction is not impressive after several months of statin therapy, how can both the physician and patient understand the root cause of the medication failure if the patient has not been fully compliant with the therapy protocol? The IC card 200 can be used to help the patient visualize these results; first by viewing the patient's recorded results which he or she has transposed onto a data file of the IC card 200, or, second, by matching compliance against a downloaded refill record of use from the patient's therapy provider such a pharmacy or medical supply house.

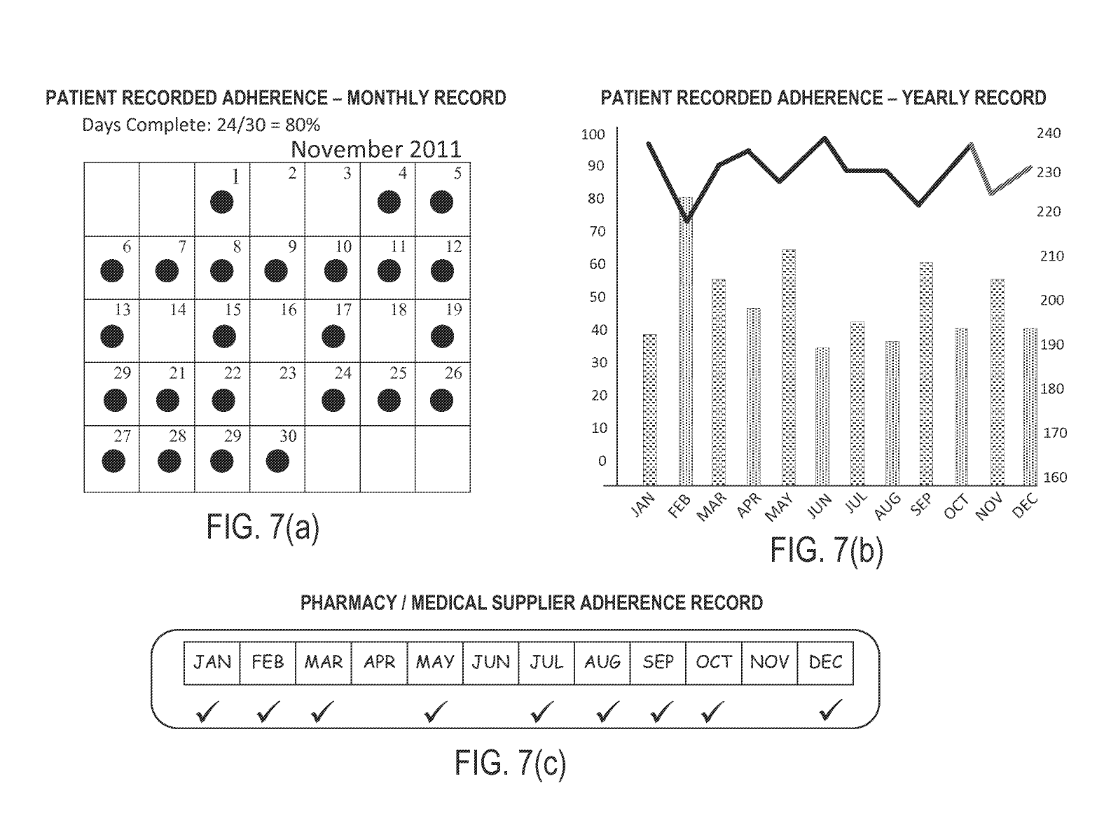

Adherence information can be entered directly onto the patient's personal computer 280, or through wireless technology, as can be reminders to use the medication as needed. The IC card 200 functions to link the biomarker and compliance progress concurrently in order to improve health care outcomes. Additionally, the adherence information can be graphically presented to the patient, care giver or health care prescriber. For example, FIG. 7(a) shows an 80% monthly adherence record for a patient. FIG. 7(b) shows a yearly adherence record in which, for each month, the adherence percentage biomarker test results are shown. FIG. 7(c) reflects information provided by the pharmacy/medical supplier as to product refills over an entire year. It is to be understood that the manner in which the adherence information is presented shown herein is meant to be illustrative, not limiting. Further, it is to be understood that certain IC card readers include displays that have limited ability to display graphical information. In such cases, the adherence information can be displayed in text format, for example.

One can easily envision in the future that payers and health plans will refuse to pay for stepped-up or more expensive therapeutic regimens until the patient has demonstrated via both the biomarker changes and medication adherence rates of commitment to therapy compliance. The systems and methods of the present invention provide such a mechanism for such accountability. In some cases biomarker results, such as genetics that demonstrate a specific propensity to elicit response to a medication cannot be altered by patient behaviors. For example, the epidermal growth factor receptor (EGRF) inhibitor drugs for certain types of cancers (such as lung cancer) will not be effective for those patients with tumors lacking in this specific cancer, and no amount of patient compliance to medication will change that. However, for those patients who test positive for EGRF, the correct medication will presumably reverse the growth of the cancer. This reversal may in turn be measured by another biomarker. In this case, however, close physician monitoring of the patient will be necessary to achieve optimal health outcomes.

The use of the IC card 200 for safety monitoring with biomarkers linked to the point of dispensation is one important and additional feature that can be used to incorporate risk management strategies into the card programming. As previously mentioned, these risk mitigation strategies are often mandated by the Food and Drug Administration (FDA) post-approval or other international regulatory body, such as the European Medicines Agency (EMEA), in order to monitor for the possibility of adverse events as products enter into larger patient populations.

In the case of many drug side effects, a surrogate marker for the side effect is often manifested in a biomarker result. For example, many liver enzyme function tests are indicators of drug toxicity, and these biomarkers can be instituted into the strategy for prospectively ensuring that a drug, biologic, or medical device is only used when safe. On the other hand, upon identification of a product's toxicity, a regulatory body, a payer or health care service provider may decide to retrospectively impose limitations on the product's use.

The IC card 200 can be programmed so that an elevated liver test would automatically disapprove a further dispensing of the product in question. This way, both the innovator company and the FDA can rest assured that patient safety is supported. Biomarkers such as alanine transferase, alkaline phosphatase and bilirubin are all used to indicate liver damage. One example for use would be Isoniazid, a drug used to treat tuberculosis. The drug has been known to cause great harm to the liver in 1-2% of patients, while slightly elevating liver enzymes in up to 20% of users. The drug is still needed in spite the potential harm, given the growing incidence of drug-resistant disease.

Of significance to the community of health care service providers, including the drug, biologic, and medical device providers, is the ability of using the IC card 200 as a tool to create a data repository of all patients with said surrogate markers. In the case of those patients whose payers may be connected to electronic health records (EHR's), the IC card 200 information can be linked back into these larger systems to measure the impact of the marker changes or product discontinuation on overall health outcomes.

While this invention has been described in conjunction with the various exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. An integrated circuit (IC) card, comprising:
a memory for storing (a) health care information for a patient, the health care information including medical record information and at least one biomarker test result, and (b) a program which when executed determines, without prior authorization, a status of a prescription;
a processor capable of executing the program to determine, without prior authorization, the status of the prescription, based at least in part on at least some of the medical record information and the at least one biomarker test result; and
an output device capable of outputting the status of the prescription;
wherein the IC card executes the program when coupled to a point-of-service computer system.

2. The integrated circuit (IC) card of claim 1, wherein the determined status for the prescription includes one of:
an approval of at least one treatment;
a denial of at least one treatment;
a denial of at least one treatment and an approval of at least one other treatment; and
a recommendation for at least one other treatment.

3. The integrated circuit (IC) card of claim 1, wherein the health care information includes one or more of phenotypic and familial information.

4. A method for integrating biomarker test results into point of dispensation decision making, comprising:
presenting a portable computing device at the point of dispensation, the portable computing device issued to a patient;
at the point of dispensation, executing a program stored on the portable computing device to:
access health care information for the patient, the health care information including at least one biomarker test result;
access information pertaining to a prescription; and
determine a status of the prescription, based at least in part on the obtained health care information including the at least one biomarker test result.

5. The method of claim 4, wherein the portable computing device is the IC card of claim 1.

6. The method of claim 5, wherein the IC card includes stored therein the health care information, the information pertaining to the prescription, and the program.

7. The method of claim 4, further comprising uploading the at least one biomarker test result to the portable computing device at the point of dispensation.

8. The method of claim 4, wherein the point of dispensation is at a pharmacy.

9. The method of claim 4, wherein the prescription includes a plurality of treatment choices, in order of preference.

10. The method of claim 4, wherein the at least one biomarker test result includes at least one genetic biomarker test result.

11. The method of claim 4, wherein the determined status for the prescription includes a payment authorization and/or payment reimbursement authorization for at least one treatment.

12. The method of claim 4, wherein the determined status for the prescription includes a payment denial and/or payment reimbursement authorization for at least one treatment.

13. The method of claim 4, wherein the determined status for the prescription includes a denial of at least one treatment.

14. The method of claim 4, wherein the determined status for the prescription includes a recommendation for at least one other treatment.

15. The method of claim 4, wherein the prescription is written by a health care prescriber at a medical office, the test results are determined at a lab, and the point of service is at a pharmacy.

16. The method of claim 4, wherein the portable computing device is a smart phone or a tablet computer.

17. The method of claim 4, further comprising recording a treatment history for the patient.

18. The method of claim 17, wherein the treatment history is self-reported by the patient.

19. The method of claim 4, further comprising the step of retrieving from the portable computing device one or more of educational information related to an illness or condition, information as to one or more drug, information about a lab test procedure, and information relating to a lab test center.

20. A method for integrating biomarker test results into point of dispensation decision making, comprising:
executing a program stored on a computing device to:
access health care information for the patient, the health care information including at least one biomarker test result;
access information pertaining to a prescription; and
determine a status of the prescription, based at least in part on the obtained health care information including the at least one biomarker test result.
